(19) United States
(12) Patent Application Publication
(10) Pub. No.: US 2019/0295789 A1
(43) Pub. Date: Sep. 26, 2019

(54) ELECTRICAL SWITCH

(71) Applicant: S.A.U. Simon, Barcelona (ES)

(72) Inventors: David LOPEZ LOPEZ, Barcelona (ES); Jordi ARDERIU COSTAS, Barcelona (ES)

(21) Appl. No.: 16/306,063

(22) PCT Filed: Jun. 1, 2017
(86) PCT No.: PCT/ES2017/070389

§ 371 Date: Nov. 30, 2018

(30) Foreign Application Priority Data
Jun. 2, 2016 (ES) P201630733

(51) Int. Cl. H01H 21/36; H01H 21/24

(52) U.S. Cl. CPC H01H 21/36; H01H 21/24

(57) ABSTRACT

The electric switch comprises at least one actuation point (3) for electric connection and disconnection, so that the application of pressure to said actuation point (3) causes the displacement of a shaft (1), which rotates a pivoting contact (8) which causes the electric connection or disconnection, and it is characterized in that said shaft (1) is associated with a connecting rod (9), which transmits the rotational movement to said pivoting contact (8).

It allows the sensation of the user to be the same as an electronic switch, although in reality it is a mechanical switch, since the pressure to be exerted on the key is similar to the electric switches of this type with electronic mechanism.

P The present invention relates to an electric switch, comprising a key, the operation of which connects or disconnects an electric device.

### BACKGROUND OF THE INVENTION

The known electric switches currently comprise a key mounted on a base provided with an actuation point, said key being pivotable about a pivoting axis. This key defines two positions: a first contact position or electric connection position and a second disconnection position or rest position.

From this second rest position, when the user presses the key, it switches to the first contact position, in which it can be maintained or, if desired, it can automatically return to the second position, e.g. by a spring. When this automatic return occurs, each time the key is pressed, the electric contact will be connected and disconnected when the key is not pressed, or the electric contact will be connected and disconnected alternately when the key is pressed.

In these electric switches in which the key automatically returns to its rest position, they may be of mechanical or electronic type. This kind of electric switches which use electronic mechanisms for the electric actuation have the advantage that the pressure that must be applied on the key is reduced compared to electric switches with a mechanical mechanism. However, these electronic mechanisms are substantially more expensive than the mechanical mechanisms and increase the cost price of the electric switch.

In electric switches of this type with a mechanical mechanism, the pressure to be applied on the key is greater, since the spring force provided by two springs must be exceeded, one for the operation of a pivoting contact, and another for the return of the key to the rest position. In addition, the need for two springs increases the cost of the electric switch to some extent.

An example of this type of electric switch is disclosed in document ES 1 064 532 U, of the same applicant as the present application.

Therefore, the object of the present invention is to provide an electric switch with a mechanical mechanism which provides the user with the sensation of using an electronic type switch, but with the price of a mechanical type switch.

### DISCLOSURE OF THE INVENTION

With the electric switch of the invention said drawbacks are solved, presenting other advantages that will be described below.

The electric switch according to the present invention comprises at least one key rocking about a rotation axis and a base provided with at least one actuation point of electric connection or disconnection for each key, so that the rocking of the key presses said actuation point and causes the displacement of a shaft, which rotates a pivoting contact that causes the electric connection or disconnection, and characterized in that said shaft is associated with a connecting rod, which is the one that transmits the pivoting movement to said pivoting contact.

According to a preferred embodiment, said connecting rod comprises two protrusions at the end most remote from the actuation point, one of which contacts said pivoting contact in its rocking movement to cause the electric connection or disconnection.

Moreover, advantageously said connecting rod comprises a first inclined surface and said shaft comprises a second inclined surface, said inclined surfaces being in contact with each other when the key is pressed.

Preferably, the end of said shaft most remote from said actuation point comprises a portion offset from the rest of the shaft, said second inclined surface being defined in said offset portion.

Advantageously, the connecting rod also comprises a contact portion adjacent to, or following, said first inclined surface, the shaft end most remote from the actuation point being in contact with said contact portion.

The electric switch according to the present invention preferably comprises a helical spring placed about said axis.

According to a preferred embodiment, the switch also comprises a rest area of the pivoting contact. The rest area of the pivoting contact preferably extends in the direction perpendicular to the axis of the connecting rod, to reduce the angle of travel of the contact to the rest position. This additional rest area has an extension so that the angle formed by an axis passing through the point closest to the axis of the connecting rod and the base of the pivoting contact with the vertical passing through the axis of the connecting rod is less than 0 degrees.

With the rest area of the pivoting contact, the drive force is reduced.

With the electric switch, according to the present invention the user sensation is that he/she uses an electronic switch, although in reality it is a mechanical switch, since the pressure to be exerted on the key is similar to the electric switches of this type with electronic mechanism, only being necessary to overcome the spring force of one spring. In addition, its cost is even lower than in the known switches with mechanical mechanism, since it does not require a second spring.

### BRIEF DESCRIPTION OF THE DRAWINGS

For better understanding of what has been disclosed, are attached some drawings in which, schematically and only by way of a non-limiting example, a practical case of embodiment is shown.

FIG. 1 is a sectional view of the upper portion of the electric switch of the present invention in its rest position;

FIG. 2 is a sectional view of the upper portion of the electric switch of the present invention in its actuation position;

FIG. 3 is a sectional view of the lower portion of the electric switch of the present invention in its rest position;

FIG. 4 is a sectional view of the lower portion of the electric switch of the present invention in its actuation position;

FIGS. 5 and 6 are schematic views of the lower portion of the electric switch of the present invention in its rest position; and

FIGS. 7 and 8 are schematic views of the lower portion of the electric switch of the present invention in its actuation position.

### DESCRIPTION OF A PREFERRED EMBODIMENT

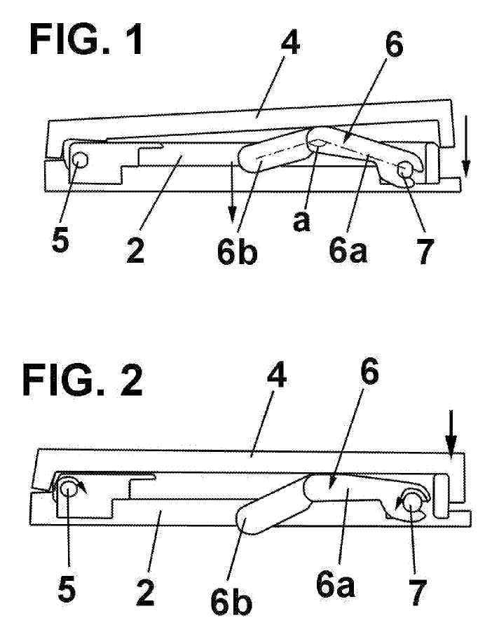

The upper portion of the electric switch according to a possible embodiment of the present invention is shown in FIGS. 1 and 2 to facilitate a complete understanding of the present invention. This upper portion of the electric switch could be conventional, as in any electric switch currently known.

The electric switch according to the present invention comprises one or more bases 2 and one or more keys 4. In the case of using more than one key 4, preferably each key is of the same size.

In addition, said base 2 or each base 2 is provided with an actuation point 3 for connection and disconnection, each key 4 being pivotable with respect to a pivoting axis 5, which pivoting presses said actuation point 3 and causes the electric connection or disconnection.

In FIGS. 1 and 2 it can be seen that the base 2 comprises a pivoting actuator 6 formed by a proximal section 6a and a distal section 6b, defining an angle (a). For example, said angle (a) is greater than or equal to 90° and preferably it may be comprised between 110° and 130°, for example, 120°.

Furthermore, said proximal portion 6a of the actuator 6 comprises a rotation axis 7 at its end remote from the center of the base and said distal portion 6b is in contact with the actuation point 3 when said key 4 is pressed.

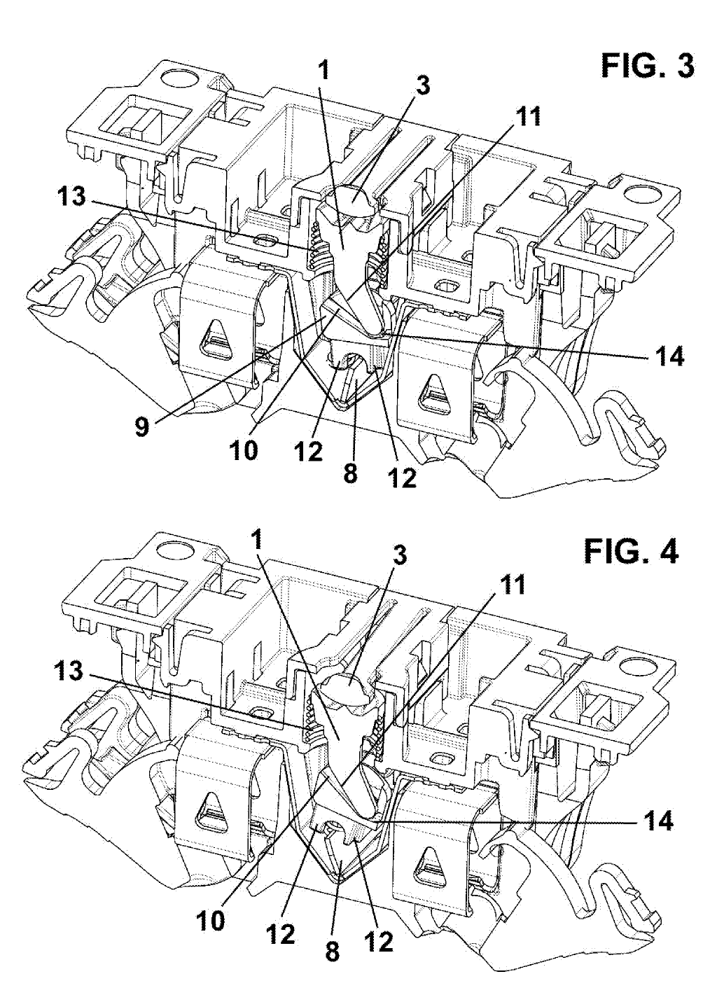

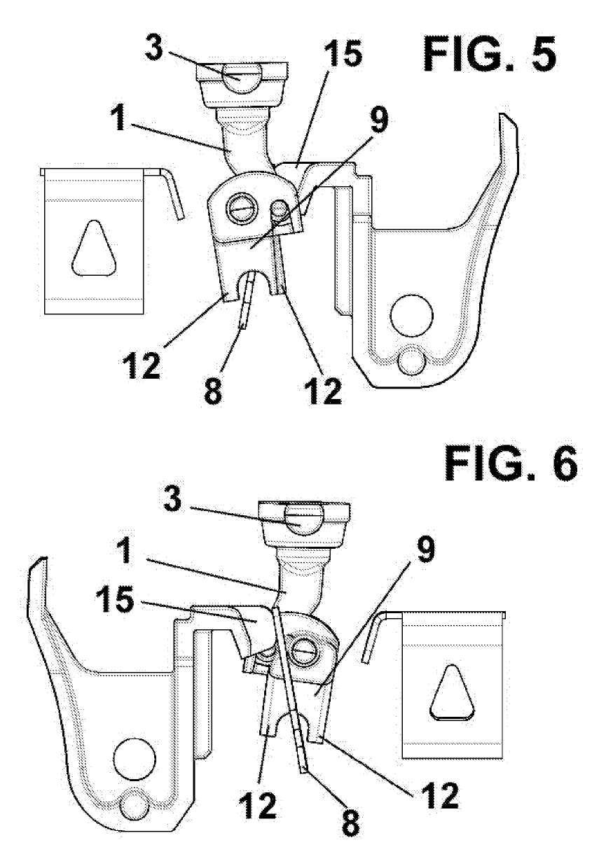

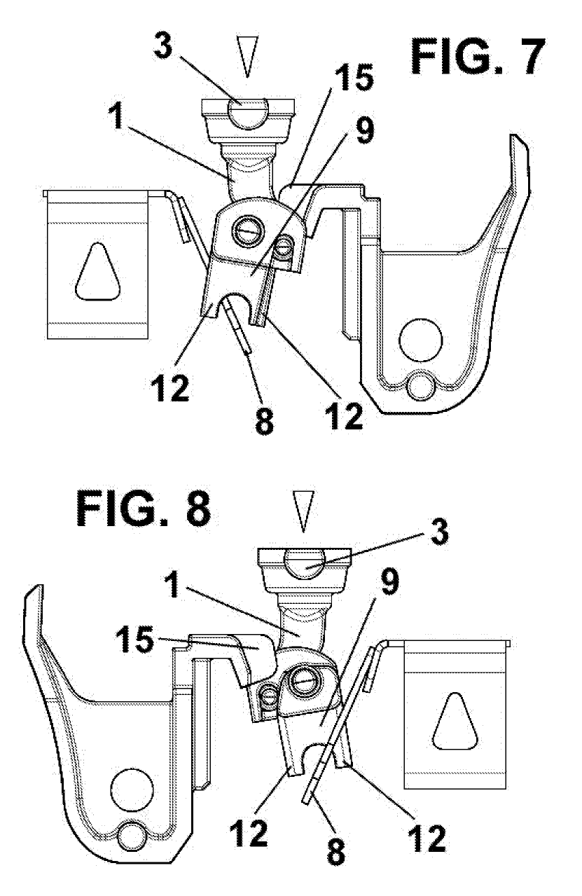

In FIGS. 3 and 4 the lower portion of the electric switch according to the present invention is shown.

The electric switch comprises a shaft 1, on which an actuation point 3 acts. Said shaft 1 is longitudinally movable, and a helical spring 13 is placed around it. The shaft has at least one connection point with the helical spring 13 at a height near its end closest to the actuation point 3.

Said shaft 1 is associated with a connecting rod 9, which is rotatable or swingable between the positions shown in FIGS. 3 and 4. Said connecting rod 9 is the one that moves a pivoting contact 8, which is the one that determines the electric connection or disconnection. Said displacement is done by a pair of protrusions 12 of the connecting rod 9, which are arranged at the end most remote from the actuation point 3. One end of the pivotal contact 8 is located between the protrusions 12 of the connecting rod 9 so that the movement of the connecting rod 9 pushes the end of the pivoting contact 8, causing it to pivot with respect to its other end, which remains fixed at a point 15 of the bottom of the housing located between the electric contacts, so that the surface of the pivoting contact will change from being free in the disconnection state to contacting the electric contact in the connection state.

Said connecting rod 9 further comprises a first inclined surface 10, disposed at the end opposite to said protrusions 12. At that end, the connecting rod 9 also comprises a contact portion 14.

On the other hand, said shaft 1 comprises at its end remote from the actuation point 3 a portion offset from the rest of the shaft 1, defining a second inclined surface 11.

In the rest position, when the key 4, shown in FIG. 3, is not pressed, the distal end of the offset portion is in contact with said contact portion 14 of the connecting rod 9. On the other hand, in the actuating position, when the key 4, shown in FIG. 4, is pressed, both inclined surfaces 10 of the connecting rod 11 and of the shaft 1 are in contact with each other.

The switch of the present invention may also comprise a rest area 15 of the pivoting contact 8. The rest area 15 of the pivoting contact preferably extends in the direction perpendicular to the axis of the connecting rod 9, to reduce the angle of travel of the contact to the rest position. This additional rest area 15 has an extension so that the angle forming an axis passing through the point closest to the axis of the connecting rod and the base of the rotating contact 8 with the vertical passing through the axis of the connecting rod 9 is less than 0 degrees.

The operation of the electric switch according to the present invention is as follows.

When a user wishes to activate or deactivate an electric device, he/she presses the key 4, through an actuator 6 the actuation point 3 is pressed, which causes the longitudinal displacement of the shaft 1 (downwardly according to the position shown in FIG. 3).

This longitudinal displacement of the shaft 1 causes the connecting rod to pivot thanks to the portion offset from the shaft 1, which in turn causes the displacement of the pivoting contact 8 by the protrusions 12 of the connecting rod 9.

When he/she stops pressing the key 4, the pivoting contact 8, the connecting rod 9 and the shaft 1 will be in their rest position by the action of the helical spring 13.

Although reference has been made to specific embodiments of the invention, it is apparent to a person skilled in the art that the described electric switch is susceptible of numerous variations and modifications, and that all the details mentioned can be replaced by other technically equivalents, without departing from the scope of protection defined by the appended claims.

1. An electric switch comprising at least one actuation point (3) for electric connection and disconnection, so that the application of pressure to said actuation point (3) causes the displacement of a shaft (1), which rotates a pivoting contact (8) which causes the electric connection or disconnection, characterized in that said shaft (1) is associated with a connecting rod (9), which transmits the rotational movement to said pivoting contact (8).

2. The electric switch according to claim 1, wherein said connecting rod (9) comprises two protrusions (12) at the end most remote from the actuation point (3), one of which contacts said pivoting contact (8) in its rotation movement to cause the electric connection or disconnection.

3. The electric switch according to claim 2, wherein said connecting rod (9) comprises a first inclined surface (10) and said shaft (1) comprises a second inclined surface (11), said inclined surfaces (10 11) being in contact to each other when the actuation point (3) is pressed.

4. The electric switch according to claim 3, wherein the end of said shaft (1) most remote from said actuation point (3) comprises a portion offset from the rest of the shaft (1), said second inclined surface (11) being defined in said offset portion.

5. The electric switch according to claim 4, wherein the connecting rod (9) comprises a contact portion (14) next to said first inclined surface (10), the end of the shaft (1) most remote from the actuation point (3) in contact with said contact portion (14).

6. The electric switch according to claim 5, comprising a helical spring (13) placed around said shaft (1).

7. The electric switch according to claim 6, wherein the helical spring (13) is connected to the shaft (1) at a height near its end closest to the actuation point (3).

8. The electric switch according to any one of claim 7, further comprising a rest area (15) of the pivoting contact (8).

9. The electric switch according to claim 8, wherein the rest area (15) of the pivoting contact (8) extends in the direction perpendicular to the axis of the connecting rod (9).

10. The electric switch according to claim 8, wherein the rest area (15) has an extension, so that the axis of the end point of the rest area (15) in the direction of the axis of the connecting rod also passes by the base of the contact (8), forming an angle with the vertical passing through the axis of the connecting rod (9) which is lower than 0 degrees.

11. The electric switch according to claim 3, wherein the connecting rod (9) comprises a contact portion (14) next to said first inclined surface (10), the end of the shaft (1) most remote from the actuation point (3) in contact with said contact portion (14).

12. The electric switch according to claim 1, wherein said connecting rod (9) comprises a first inclined surface (10) and said shaft (1) comprises a second inclined surface (11), said inclined surfaces (10 11) being in contact to each other when the actuation point (3) is pressed.

13. The electric switch according to claim 12, wherein the end of said shaft (1) most remote from said actuation point (3) comprises a portion offset from the rest of the shaft (1), said second inclined surface (11) being defined in said offset portion.

14. The electric switch according to claim 13, wherein the connecting rod (9) comprises a contact portion (14) next to said first inclined surface (10), the end of the shaft (1) most remote from the actuation point (3) in contact with said contact portion (14).

15. The electric switch according to claim 12, wherein the connecting rod (9) comprises a contact portion (14) next to said first inclined surface (10), the end of the shaft (1) most remote from the actuation point (3) in contact with said contact portion (14).

16. The electric switch according to claim 1, comprising a helical spring (13) placed around said shaft (1).

17. The electric switch according to claim 16, wherein the helical spring (13) is connected to the shaft (1) at a height near its end closest to the actuation point (3).

18. The electric switch according to any one of claim 1, further comprising a rest area (15) of the pivoting contact (8).

19. The electric switch according to claim 18, wherein the rest area (15) of the pivoting contact (8) extends in the direction perpendicular to the axis of the connecting rod (9).

20. The electric switch according to claim 18, wherein the rest area (15) has an extension, so that the axis of the end point of the rest area (15) in the direction of the axis of the connecting rod also passes by the base of the contact (8), forming an angle with the vertical passing through the axis of the connecting rod (9) which is lower than 0 degrees.
